(19) United States
(12) Patent Application Publication
(10) Pub. No.: US 2022/0204817 A1
(43) Pub. Date: Jun. 30, 2022

(54) ADHESIVE PRIMER FOR FLEXOGRAPHIC PLATE MOUNTING TAPE

(71) Applicant: 3M INNOVATIVE PROPERTIES COMPANY, St. Paul, MN (US)

(72) Inventors: Becky A. Jetto, Jordan, MN (US); Yu Yang, Eden Prairie, MN (US); Chunjie Zhang, Shoreview, MN (US); Jeffrey A. Peterson, Hugo, MN (US); Siwei Leng, Woodbury, MN (US); Derrick M. Poirier, Woodbury, MN (US)

(21) Appl. No.: 17/609,061

(22) PCT Filed: May 6, 2020
(86) PCT No.: PCT/IB2020/054292

§ 371 Date: Nov. 5, 2021

Related U.S. Application Data
(60) Provisional application No. 62/704,219, filed on Apr. 28, 2020.
(60) Provisional application No. 62/844,317, filed on May 7, 2019.

(51) Int. Cl. C09J 7/50; C09J 7/25; C09J 7/38

(52) U.S. Cl. CPC C09J 7/50; C09J 7/255; C09J 7/385; C09J 2301/124; C09J 2301/302; C09J 2433/00; C09J 2301/414; C09J 2479/023; C09J 2463/003; C09J 2467/006; C09J 2400/24

(57) ABSTRACT

Primer layers for adhesion of pressure sensitive adhesive materials to substrates comprise a cured primer which is the reaction product of an epoxy resin and a polyamine. The epoxy resin may be an aromatic epoxy resin. The polyamine may be a polymer such as polyethylenimine (PEI) or polyvinylamine (PVA). Two-layer constructions comprise the primer layer according to the present disclosure and a substrate layer, which may be directly bound to the primer layer. The substrate layer may comprise one or more polyester polymers, may comprise one or more polymers comprising aromatic groups, and/or may comprise polyethylene terephthalate (PET). Tapes comprise the two-layer construction according to the present disclosure and a pressure sensitive adhesive layer, which may be directly bound to the primer layer. The tape may comprise a second pressure sensitive adhesive layer borne on the opposite face of the tape and optionally a foam layer.

### FIELD OF THE DISCLOSURE

This disclosure relates to primers for bonding pressure sensitive adhesive (PSA) to a reinforcing film, such as may be used in a flexographic plate mounting tape, as well as flexographic plate mounting tapes incorporating this primer and methods of making and using such tapes.

### BACKGROUND OF THE DISCLOSURE

Flexographic plate mounting tapes are used to mount flexographic printing plates to plate cylinders in a flexographic printing press. The following references may be relevant to the general field of technology of the present disclosure: JP 2004/285297, US 2003/0049415, US 2006/0145127, US 2011/0019280, US 2015/0361307, U.S. Pat. Nos. 5,156,904, 6,915,741, 8,152,944, 8,802,226, and 8,962,777.

### SUMMARY OF THE DISCLOSURE

Briefly, the present disclosure provides primer layers for adhesion of pressure sensitive adhesive materials to substrates, where the primer layer comprises a cured primer which is the reaction product of an epoxy resin and a polyamine. In some embodiments, the epoxy resin is an aromatic epoxy resin. In some embodiments, the polyamine is a polymer, such as polyethylenimine (PEI) or polyvinylamine (PVA). Additional embodiments of the primer layer of the present disclosure are described below under “Selected Embodiments.”

In another aspect, the present disclosure provides two-layer constructions comprising the primer layer according to the present disclosure and a substrate layer, which may be directly bound to the primer layer. In various embodiments, the substrate layer may comprise one or more polyester polymers, may comprise one or more polymers comprising aromatic groups, and/or may comprise polyethylene terephthalate (PET). In some embodiments, the substrate layer comprises an oriented film. Additional embodiments of the two-layer constructions of the present disclosure are described below under “Selected Embodiments.”

In another aspect, the present disclosure provides tapes comprising the two-layer construction according to the present disclosure and a first pressure sensitive adhesive layer comprising a pressure sensitive adhesive material, which may be directly bound to the primer layer. In various embodiments, the pressure sensitive adhesive material may comprise polyacrylate polymer, and/or may comprise a polymer comprising acidic polar monomer units. In various embodiments, the tape may comprise a second pressure sensitive adhesive layer borne on a face of the tape opposite the first pressure sensitive adhesive layer, and/or a foam layer. Additional embodiments of the tapes of the present disclosure are described below under “Selected Embodiments.”

In another aspect, the present disclosure provides methods of making the two-layer constructions according to the present disclosure comprising steps of: a) providing a substrate layer; b) coating the substrate layer with a coating mixture comprising a curable aromatic epoxy resin and a polyamine; which may additionally comprise steps of c) reacting the curable aromatic epoxy resin with the polyamine so as to generate a primer layer comprising a cured primer; d) orienting (stretching) the substrate layer in a first direction; and e) orienting (stretching) the substrate layer in a second direction. In some embodiments, steps a)-e) are carried out in the order a), d), b), c), e). Additional embodiments of methods of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this application:
“directly bound” refers to two materials that are in direct contact with each other and bound together;
“(meth)acrylate” includes, separately and collectively, methacrylate and acrylate;
“optically opaque” means passing less than 50% of light in the optical range, in some embodiments less than 40%, in some embodiments less than 30%, and in some embodiments less than 10%; and
“pressure sensitive adhesive (PSA)” means materials having the following properties: a) tacky surface, b) the ability to adhere with no more than finger pressure, c) the ability to adhere without activation by any energy source, d) sufficient ability to hold onto the intended adherend, and e) sufficient cohesive strength to be removed cleanly from the adherend; which materials typically meet the Dahlquist criterion of having a storage modulus at 1 Hz and room temperature of less than 0.3 MPa.

All scientific and technical terms used herein have meanings commonly used in the art unless otherwise specified.

As used in this specification and the appended claims, past tense verbs such as “coated” and “oriented” are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1 is a cross-section of one embodiment of a flexographic plate mounting tape according to the present disclosure.

FIG. 2 is a cross-section of one embodiment of a flexographic plate mounting tape according to the present disclosure.

FIG. 3 is a cross-section of one embodiment of a flexographic plate mounting tape according to the present disclosure.

### DETAILED DESCRIPTION

The present disclosure provides a primer for bonding pressure sensitive adhesive (PSA) to the reinforcing film in a flexographic plate mounting tape. The present disclosure additionally provides flexographic plate mounting tapes incorporating this primer, and methods of making and using such tapes.

Flexographic plate mounting tapes are used to mount flexographic printing plates to plate cylinders in a flexographic printing press. Mounted flexographic printing plates may require washing between printing runs. The washing process may cause “nibs” of adhesive from the flexographic plate mounting tape to form. These small particles can compromise print quality by creating spots or flaws in the printed articles. Use of the primer according to the present disclosure provides reduced adhesive nib formation during in situ plate washing. Flexographic plate mounting tapes made with the subject primer demonstrate improved rub resistance, which results in reduced adhesive nib formation.

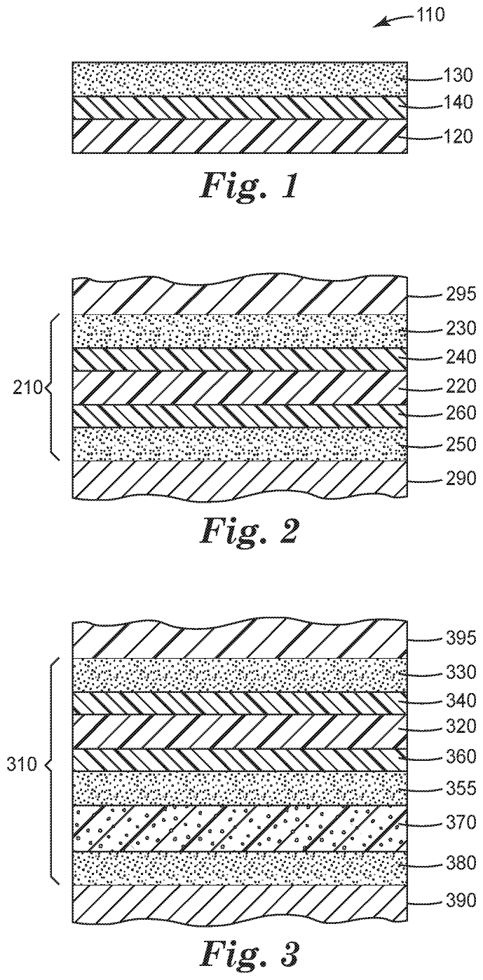

With reference to FIG. 1, one embodiment of flexographic plate mounting tape 110 according to the present disclosure includes carrier layer 120 and PSA layer 130 bound to carrier layer 120 through primer layer 140. In some embodiments, carrier layer 120 is immediately adjacent to and directly bound to primer layer 140. In some embodiments, primer layer 140 is immediately adjacent to and directly bound to PSA layer 130. With reference to FIG. 2, a further embodiment of flexographic plate mounting tape 210 according to the present disclosure includes carrier layer 220, first PSA layer 230 bound to carrier layer 220 through first primer layer 240, and second PSA layer 250 bound to the opposite face of carrier layer 220 through second primer layer 260. In some embodiments, carrier layer 220 is immediately adjacent to and directly bound to first primer layer 240. In some embodiments, first primer layer 240 is immediately adjacent to and directly bound to first PSA layer 230. In some embodiments, carrier layer 220 is immediately adjacent to and directly bound to second primer layer 260. In some embodiments, second primer layer 260 is immediately adjacent to and directly bound to second PSA layer 250. In some embodiments, first PSA layer 230 and second PSA layer 250 have the same composition. In some embodiments, first PSA layer 230 and second

PSA layer 250 differ in composition. In some embodiments, first primer layer 240 and second primer layer 260 have the same composition. In some embodiments, first primer layer 240 and second primer layer 260 differ in composition. In some applications flexographic plate mounting tape 210, flexographic printing plate 295 is attached to plate cylinder 290 of a flexographic printing press (not shown) by use of flexographic plate mounting tape 210. Typically flexographic plate mounting tape 210 is bound to flexographic printing plate 295 through first PSA layer 230 and bound to plate cylinder 290 through second PSA layer 250.

With reference to FIG. 3, a further embodiment of flexographic plate mounting tape 310 according to the present disclosure includes carrier layer 320, first PSA layer 330 bound to carrier layer 320 through first primer layer 340. In some embodiments, carrier layer 320 is immediately adjacent to and directly bound to first primer layer 340. In some embodiments, first primer layer 340 is immediately adjacent to and directly bound to first PSA layer 330. Foam layer 370 is bound to carrier layer 320, optionally through second primer layer 360 and internal adhesive layer 355. In some embodiments, foam layer 370 is immediately adjacent to and directly bound to carrier layer 320. In some embodiments, foam layer 370 is immediately adjacent to and directly bound to internal adhesive layer 355 and internal adhesive layer 355 is immediately adjacent to and directly bound to carrier layer 320. In some embodiments, foam layer 370 is immediately adjacent to and directly bound to internal adhesive layer 355, internal adhesive layer 355 is immediately adjacent to and directly bound to second primer layer 360, and second primer layer 360 is immediately adjacent to and directly bound to carrier layer 320. In some embodiments, second primer layer 360 is omitted and internal adhesive layer 355 is immediately adjacent to and directly bound to carrier layer 320. In some embodiments, foam layer 370 bears one or more additional adhesive layers 380. In some embodiments, additional adhesive layers 380 include additional PSA layers. In some embodiments, additional adhesive layers 380 include additional hot melt adhesive layers. In some applications flexographic plate mounting tape 310, flexographic printing plate 395 is attached to plate cylinder 390 of a flexographic printing press (not shown) by use of flexographic plate mounting tape 310. Typically flexographic plate mounting tape 310 is bound to flexographic printing plate 395 through first PSA layer 330 and bound to plate cylinder 390 through additional adhesive layer 380.

With regard to all of the embodiments of FIGS. 1-3, outer adhesive layers (such as PSA layer 130, first PSA layer 230, second PSA layer 250, first PSA layer 330, and additional adhesive layer(s) 380) may comprise relief features in their outer surface (not shown). With regard to all of the embodiments of FIGS. 1-3, outer adhesive layers (such as PSA layer 130, first PSA layer 230, second PSA layer 250, PSA layer 330, and additional adhesive layer(s) 380) may bear a release liner (not shown). In some such embodiments, the release liner has an embossed surface facing the adhesive layer which imparts and/or matches relief features in the outer surface of the PSA layer.

In some embodiments of the articles depicted in FIGS. 1-3, PSA layer 130, first PSA layer 230 and first PSA layer 330 have a thickness of at least 15 micrometers, in some embodiments at least 20 micrometers, and in some embodiments at least 30 micrometers. In some such embodiments those PSA layers have thickness of less than 200 micrometers, in some less than 100 micrometers, and in some less than 70 micrometers. In some embodiments, other adhesive layers are subject to the same constraints on thickness. In some embodiments of the articles depicted in FIGS. 1-3, primer layer 140, first primer layer 240 and first primer layer 340 have thickness of at least 40 nanometers, in some embodiments at least 80 nanometers, and in some embodiments at least 120 nanometers. In some such embodiments those primer layers have thickness of less than 500 nanometers, in some less than 350 nanometers, and in some less than 200 nanometers. In some embodiments, other primer layers are subject to the same constraints on thickness. In some embodiments of the articles depicted in FIGS. 1-3, carrier layers 120, 230 and 330 have a thickness of at least 10 micrometers, in some embodiments at least 15 micrometers, and in some embodiments at least 20 micrometers. In some such embodiments those carrier layers have thickness of less than 120 micrometers, in some less than 80 micrometers, and in some less than 40 micrometers. In some embodiments of the article depicted in FIGS. 3, foam layer 370 has a thickness of at least 200 micrometers, in some embodiments at least 300 micrometers, and in some embodiments at least 400 micrometers. In some such embodiments foam layer 370 has a thickness of less than 2500 micrometers, in some less than 2000 micrometers, and in some less than 1500 micrometers.

In some embodiments, the primer layer comprises a crosslinked polymer and has an atomic nitrogen content of greater than 6 wt %, in some embodiments greater than 8 wt %, in some greater than 10 wt %, in some greater than 12 wt %, in some greater than 14 wt %, and in some greater than 16 wt %. In some embodiments, the primer layer has a ratio of atomic weight percent of oxygen to nitrogen of less than 3.0, in some less than 2.5, in some less than 2.0 and in some less than 1.5. In some embodiments, the crosslinked polymer comprises at least 50 wt % of the total weight of the primer layer, in some at least 60 wt %, in some at least 70 wt %, and in some at least 80 wt %. The crosslinked polymer is the reaction product of a polyamine and a curable epoxy resin, in some embodiments the reaction product of a polymeric polyamine polymer and a curable epoxy resin. In some embodiments the polyamine includes primary, secondary, and tertiary amine groups. In some embodiments the polyamine is a polyethylenimine (PEI). In some embodiments the polyamine includes only primary amine groups and no secondary or tertiary amine groups. In some embodiments the polyamine is a polyvinylamine (PVA). In various embodiments the polyamine may be a high molecular weight polyamine, having a weight average molecular weight (Mw) of greater than 20,000 grams/mole, greater than 60,000 grams/mole, greater than 80,000 grams/mole, greater than 1250,000 grams/mole, greater than 250,000 grams/mole, or in some embodiments greater than 600,000 grams/mole. In various embodiments the polyamine may be a low molecular weight polyamine, having a weight average molecular weight (Mw) of less than 20,000 grams/mole, less than 10,000 grams/mole, less than 2,000 grams/mole, less than 600 grams/mole, or in some embodiments less than 300 grams/mole. In some embodiments the curable epoxy resin is an aromatic curable epoxy resin. In particular, the use of an aromatic curable epoxy resin in a primer for application to a substrate comprising an aromatic polymer may provide enhanced adhesion.

A polyethylenimine (PEI) is a polymer comprising repeating units according to the formulas:

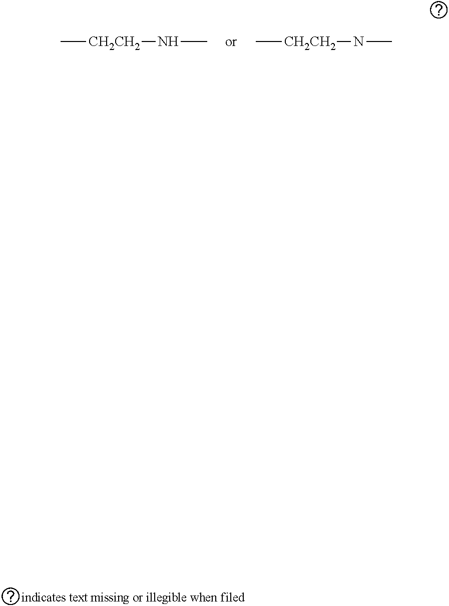

The amine nitrogen may be secondary, in linear segments of the polymer, or may be tertiary, to form branch points. PEI's may include primary amine end groups. Linear PEI's contain all secondary amines, excluding primary amine end groups. Branched PEI's contain secondary and tertiary amine groups, as well as primary amine end groups. Totally branched dendrimeric forms are also reported. PEI's are sometimes referred to as polyaziridine polymers, since they may be composed of monomer units derived from aziridine monomers.

The primer may be applied to the carrier as a mixture of a polyamine and a curable epoxy resin. The primer may be applied to the carrier as a solution or suspension in aqueous solvent. The primer may be applied to the carrier by any suitable method, including spraying, coating, brushing, immersion, and the like. After application, the primer may be heated to accelerate reaction of the polyamine and the curable epoxy resin.

In some embodiments, the present primer may be applied to a carrier and stored for long periods before application of adhesive, rather than requiring prompt application of adhesive. This characteristic allows greater flexibility in manufacture. Without wishing to be bound by theory, it is believed that this characteristic results from the condition that the reactive groups of the primer (such as epoxide functional groups) are involved in binding to the carrier, but are not involved in binding to the adhesive, and thus do not need to be kept “live” or “active” until adhesive can be applied. In contrast, other priming methods require immediate application of PSA to the primer for adequate adhesion, or application within minutes or hours. Furthermore, in some embodiments of the present disclosure, a primed carrier may be stored in roll form without undue adhesion of the primer to the backside of the carrier, even without a liner.

In some embodiments, the primer layer additionally comprises fillers. Any suitable fillers may be used, including silica particles such as fumed silica and the like.

The carrier layer (also referred to as substrate herein) may comprise any suitable polymeric material. In some embodiments, the carrier layer comprises a polyester polymer, a polypropylene polymer, or a polycarbonate polymer. In some embodiments, the carrier layer comprises a polyester polymer. In some embodiments, the carrier layer comprises an aromatic polymer. In some embodiments, the carrier layer comprises an aromatic polyester polymer. In some embodiments, the carrier layer comprises polyethylene terephthalate (PET). In some embodiments, the carrier layer is an oriented (stretched) film. In some embodiments, the carrier layer is oriented (stretched) on at least one axis prior to application of primer. In some embodiments, the carrier layer is oriented (stretched) on two axes prior to application of primer. In some embodiments, the carrier layer is oriented (stretched) on at least one axis after application of primer. This may aid in penetration of the primer into the carrier. In some embodiments, the carrier layer is oriented (stretched) on two axes after application of primer. In some embodiments, the carrier layer is oriented (stretched) on one axis prior to application of primer and oriented (stretched) on a second axis after application of primer. In some embodiments, the carrier layer may comprise a foam.

In some embodiments, the carrier layer additionally comprises fillers. In some embodiments, fillers act as slip additives by creating a microtextured film surface. Any suitable fillers may be used, including clays, aluminum silicate and the like.

Any suitable PSA layers may be used. In some embodiments, the PSA comprises a polyacrylate polymer. In some embodiments, the PSA comprises a tackified polyacrylate. In some embodiments, the PSA comprises a polyacrylate polymer comprising units derived from ionic monomers in an amount of 0.1-20.0 wt % of the total weight of the polyacrylate polymer, in some embodiments 0.5-10.0 wt %, and in some embodiments 3.0-10.0 wt %. In some embodiments, the PSA comprises a polyacrylate polymer comprising units derived from acrylic acid monomers in an amount of 0.1-10.0 wt % of the total weight of the polyacrylate polymer, in some embodiments 0.5-10.0 wt %, and in some embodiments 3.0-10.0 wt %. In some embodiments, the PSA comprises a tackified rubber. In some embodiments, the PSA comprises a tackified natural rubber. In some embodiments, the PSA comprises a tackified synthetic rubber. In some embodiments comprising multiple PSA layers, all PSA layers are of the same composition. In some embodiments comprising multiple PSA layers, PSA layers differ in composition.

Flexographic printing plates may be of any suitable material. In some embodiments, flexographic printing plates comprise polymeric materials, which in some embodiments are one or more polyesters.

Flexographic printing press plate cylinders may be of any suitable material. In some embodiments, flexographic printing press plate cylinders comprise polymeric materials, which in some embodiments are one or more polyurethanes. In some embodiments, flexographic printing press plate cylinders comprise metal materials, which in some embodiments are steel.

Additional embodiments are recited in the Selected Embodiments and Examples below.

### Selected Embodiments

The following embodiments, designated by letter and number, are intended to further illustrate the present disclosure but should not be construed to unduly limit this disclosure.

P1. A primer layer for adhesion of a pressure sensitive adhesive material to a substrate, the primer layer comprising a cured primer which is the reaction product of an epoxy resin and a polyamine.

P2. The primer layer according to any of the preceding embodiments wherein the epoxy resin is an aromatic epoxy resin.

P3. The primer layer according to any of the preceding embodiments wherein the cured primer comprises at least 50 wt % of the total weight of the primer layer.

P4. The primer layer according to any of the preceding embodiments wherein the cured primer comprises at least 60 wt % of the total weight of the primer layer.

P5. The primer layer according to any of the preceding embodiments wherein the cured primer comprises at least 70 wt % of the total weight of the primer layer.

P6. The primer layer according to any of the preceding embodiments wherein the cured primer comprises at least 80 wt % of the total weight of the primer layer.

P7. The primer layer according to any of the preceding embodiments wherein the cured primer comprises at least 90 wt % of the total weight of the primer layer.

P8. The primer layer according to any of the preceding embodiments wherein the polyamine is a polymer.

P9. The primer layer according to any of the preceding embodiments wherein the polyamine is a polyethylenimine (PEI).

P10. The primer layer according to any of the preceding embodiments wherein the polyamine is a polyvinylamine (PVA).

P11. The primer layer according to any of the preceding embodiments additionally comprising 0.1-40.0 wt % inorganic filler.

P12. The primer layer according to any of the preceding embodiments additionally comprising 2.0-20.0 wt % inorganic filler.

P13. The primer layer according to any of the preceding embodiments additionally comprising essentially no inorganic filler.

P14. The primer layer according to any of the preceding embodiments additionally comprising no inorganic filler.

P15. The primer layer according to embodiment P11 or P12 wherein the inorganic filler comprises silica.

P16. The primer layer according to embodiment P11 or P12 wherein the inorganic filler comprises fumed silica.

TL1. A two-layer construction comprising the primer layer according to any of the preceding embodiments and a substrate layer.

TL2. The two-layer construction according to embodiment TL1 wherein the primer layer is immediately adjacent to the substrate layer.

TL3. The two-layer construction according to embodiment TL1 wherein the primer layer is immediately adjacent to and directly bound to the substrate layer.

TL4. The two-layer construction according to any of embodiments TL1-TL3 wherein the substrate layer comprises one or more materials selected from the group consisting of polyester polymers, polypropylene polymers, and polycarbonate polymers.

TL5. The two-layer construction according to any of embodiments TL1-TL3 wherein the substrate layer comprises one or more polyester polymers.

TL6. The two-layer construction according to any of embodiments TL1-TL5 wherein the substrate layer comprises one or more polymers comprising aromatic groups.

TL7. The two-layer construction according to any of embodiments TL1-TL6 wherein the substrate layer comprises polyethylene terephthalate (PET).

TL8. The two-layer construction according to any of embodiments TL1-TL7 wherein the substrate layer comprises an oriented film.

TL9. The two-layer construction according to any of embodiments TL1-TL8 wherein the substrate layer has a haze of greater than 6%.

TL10. The two-layer construction according to any of embodiments TL1-TL9 which is optically opaque.

R1. A roll of the two-layer construction according to any of embodiments TL1-TL10 rolled upon itself.

R2. A roll of the two-layer construction according to any of embodiments TL1-TL10 rolled upon itself without a liner.

TP1. A tape comprising the two-layer construction according to any of embodiments TL1-TL10 and a first pressure sensitive adhesive layer comprising a pressure sensitive adhesive material.

TP2. The tape according to embodiment TP1 which is a flexographic plate mounting tape for adhering a flexographic printing plate to a plate cylinder in a flexographic printing press.

TP3. The tape according to any of embodiments TP1-TP2 wherein the pressure sensitive adhesive material comprises polyacrylate polymer.

TP4. The tape according to any of embodiments TP1-TP3 wherein the pressure sensitive adhesive material comprises a polymer comprising acidic polar monomer units.

TP5. The tape according to any of embodiments TP1-TP4 wherein the pressure sensitive adhesive material comprises a polymer comprising monomer units derived from acrylic acid.

TP6. The tape according to any of embodiments TP1-TP5 wherein the pressure sensitive adhesive layer is immediately adjacent to the primer layer.

TP7. The tape according to any of embodiments TP1-TP6 wherein the pressure sensitive adhesive layer is directly bound to the primer layer.

TP8. The tape according to any of embodiments TP1-TP7 additionally comprising a second pressure sensitive adhesive layer.

TP9. The tape according to any of embodiments TP1-TP7 additionally comprising a second pressure sensitive adhesive layer borne on a face of the tape opposite the first pressure sensitive adhesive layer.

TP10. The tape according to embodiment TP8 or TP9 wherein the second pressure sensitive adhesive layer is an outermost layer of the tape.

TP11. The tape according to any of embodiments TP1-TP10 wherein the first pressure sensitive adhesive layer is an outermost layer of the tape.

TP12. The tape according to any of embodiments TP1-TP11 additionally comprising a foam layer.

TP13. The tape according to embodiment TP12 additionally comprising an internal adhesive layer binding the foam layer to the substrate layer.

TP14. The tape according to any of embodiments TP1-TP13 which is optically opaque.

U1. The use of the tape according to any of embodiments TP1-TP14 to adhere a flexographic printing plate to a plate cylinder of a flexographic printing press.

MU1. A method of mounting flexographic printing plates to plate cylinders in a flexographic printing press comprising the steps of:
a) providing a segment of tape according to any of embodiments TP1-TP14;
b) adhering the segment of tape to a flexographic printing plate;
c) adhering the flexographic printing plate to a plate cylinder of a flexographic printing press by adhering the segment of tape to the plate cylinder.

MU2. A method of mounting flexographic printing plates to plate cylinders in a flexographic printing press comprising the steps of:
a) providing a segment of tape according to any of embodiments TP1-TP14;
b) adhering the segment of tape to a plate cylinder of a flexographic printing press;
c) adhering the flexographic printing plate to the plate cylinder by adhering the segment of tape to the flexographic printing plate.

MM1. A method of making a two-layer construction according to any of embodiments TL1-TL10 comprising the steps of:
a) providing a substrate layer; and
b) coating the substrate layer with a coating mixture comprising a curable aromatic epoxy resin and a polyamine.

MM2. The method according to embodiment MM1 additionally comprising the step of:
c) reacting the curable aromatic epoxy resin with the polyamine so as to generate a primer layer comprising a cured primer.

MM3. The method according to embodiment MM2 wherein step c) comprises application of heat.

MM4. The method according to any of embodiments MM2-MM3 additionally comprising the step of:
d) orienting (stretching) the substrate layer in a first direction.

MM5. The method according to embodiment MM4 wherein step d) is carried out after steps a) and b) and prior to step c).

MM6. The method according to embodiment MM4 wherein step d) is carried out after steps a) and b) and concurrently with step c).

MM7. The method according to embodiment MM4 wherein step d) is carried out after step a) and prior to steps b) and c).

MM8. The method according to any of embodiments MM2-MM3 additionally comprising the steps of:
d) orienting (stretching) the substrate layer in a first direction; and
e) orienting (stretching) the substrate layer in a second direction.

MM9. The method according to embodiment MM8 wherein steps a)-e) are carried out in the order a), b), c), d), e).

MM10. The method according to embodiment MM8 wherein steps a)-e) are carried out in the order a), d), e), b), c).

MM11. The method according to embodiment MM8 wherein steps a)-e) are carried out in the order a), d), b), c), e).

MM12. The method according to any of embodiments MM8-MM11 wherein the first direction differs from the second direction by between 45 and 135 degrees.

MM13. The method according to any of embodiments MM8-MM11 wherein the first direction differs from the second direction by between 60 and 120 degrees.

MM14. The method according to any of embodiments MM8-MM11 wherein the first direction differs from the second direction by between 75 and 105 degrees.

MMT1. A method of making a tape according to any of embodiments TP1-TP14 comprising the method according to any of embodiments MM2-MM14 and additionally comprising the step of:
f) applying a pressure sensitive adhesive material to the primer layer to generate a first pressure sensitive adhesive layer.

MMT2. The method according to embodiment MMT1 wherein step f) occurs at a time more than three days after step c).

MMT3. A method of making a tape according to any of embodiments TP1-TP14 comprising the steps of:
a) providing a two-layer construction according to any of embodiments TL1-TL10;
b) applying a pressure sensitive adhesive material to the primer layer of the two-layer construction to generate a first pressure sensitive adhesive layer.

PVA1. A primer layer for adhesion of a pressure sensitive adhesive material to a substrate, the primer layer comprising a cured primer which is the reaction product of a polyvinylamine and an aziridine.

PVA2. The primer layer according to embodiment PVA1 wherein the cured primer comprises at least 50 wt % of the total weight of the primer layer.

PVA3. The primer layer according to embodiment PVA1 wherein the cured primer comprises at least 60 wt % of the total weight of the primer layer.

PVA4. The primer layer according to embodiment PVA1 wherein the cured primer comprises at least 70 wt % of the total weight of the primer layer.

PVA5. The primer layer according to embodiment PVA1 wherein the cured primer comprises at least 80 wt % of the total weight of the primer layer.

PVA6. The primer layer according to embodiment PVA1 wherein the cured primer comprises at least 90 wt % of the total weight of the primer layer.

PVA7. The primer layer according to any of the embodiments PVA1-PVA6 additionally comprising 0.1-40.0 wt % inorganic filler.

PVA8. The primer layer according to any of the embodiments PVA1-PVA6 additionally comprising 2.0-20.0 wt % inorganic filler.

PVA9. The primer layer according to embodiment PVA7 or PVA8 wherein the inorganic filler comprises silica.

PVA10. The primer layer according to embodiment PVA7 or PVA8 wherein the inorganic filler comprises fumed silica.

The present disclosure additionally contemplates embodiments according to any of TL1-TL10, R1-R2, TP1-TP14, U1, MU1-MU2, MM1-MM14, or MMT1-MMT3 utilizing the primer layer according to any of embodiments PVA1-PVA10 in place of primer layer according to any of embodiments P1-P16.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods. cl Materials

| Designation | Description |
|---|---|
| PEI | A polyethylene imine resin having an average molecular weight (Mw) |
| | of 750,000 grams/mole, and a viscosity of 700-2100 |
| | milliPascal*seconds at 20° C., available as 31.5-34.5% solids content |
| | aqueous solution under the trade designation LUPASOL ® PS from |
| | BASF Corp., Mount Olive, NJ. |
| PVA | A linear polyvinyl amine in a colorless to yellow aqueous solution |
| | having an average molecular weight (Mw) of 340,000 grams/mole, a |
| | density of 1.08 grams/milliliter and a viscosity greater than 5,000 |
| | milliPascal*seconds, available as 20-22% solids content aqueous |
| | solution under the trade designation LUPAMIN ® 9095 from BASF |
| | Corp., Mount Olive, NJ. |
| Wetting Agent | A concentrated sulfosuccinate-type wetting agent, dioctyl sodium |
| | sulfosuccinate, clear/light yellow in appearance with a molecular |
| | weight of 444 and a specific gravity at 25° C. of 1.11. Available under |
| | the trade designation of GEMTEX ® SC-85-P from Innospec |
| | Performance Chemicals, Salisbury, North Carolina. |
| Fluoro- | A non-ionic superwetting agent, ethoxylated acetylenic gemini |
| surfactant | surfactant, amber in appearance with a viscosity of 205 millipascal |
| | seconds at 25° C. and a specific gravity at 25° C. of 1.00. Available |
| | under the trade designation of DYNOL ™ 607 from Evonik Nutrition & |
| | Care GmbH, Parsippany, New Jersey. |
| PU | A water-borne aliphatic urethane dispersion, 33 percent solids, pH of |
| | 8.3, viscosity at 25° C., Brookfield 300 milliPascal*seconds, a weight |
| | per gallon at 25 C of 8.8 pounds available under the trade designation |
| | NEOREZ R960 from Zeneca Resins, Wilmington, MA. |
| Acrylic | A thermoset acrylic polymer containing a combination of acrylic latex |
| Polymer | and melamine/formaldehyde curing resin with triethyl amine that is a |
| | white, milky liquid with an acrylic or ammonia odor, a pH of 10.0, |
| | maximum Brookfield viscosity of 200 centipoise, a particle size of 90- |
| | 130 nanometers, available under the trade designation RHOPLEX 3208 |
| | from The Dow Chemical Company, Midland, MI. |
| Crosslinker 1 | Pentaerythritol Tris (3-(1-Aziridinyl) Propionate), |
| | 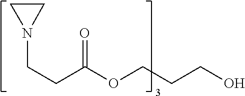 |
| | an ethylene imine based polyaziridine crosslinker with an aziridine |
| | content of 6.4-7.3 milliequivalents/gram, which is a slightly amber |
| | colored clear liquid having a density at 25° C. of 1.155-1.175 |
| | grams/milliliter and a viscosity at 25° C. less than 4000 centipoise, |
| | available under the trade name of PZ-33 POLYAZIRIDINE from Poly |
| | Aziridine, LLC, Medford, NJ. The molecular structure corresponds to |
| | an atomic content of 10 wt % N, 26 wt % O, 56 wt % C and 8 wt 2% H. |
| Crosslinker 2 | A methylated high imino melamine crosslinker supplied in butanol, a |
| | clear liquid with a dynamic viscosity of 5100-16000 |
| | milliPascal*seconds at 23° C., available under the trade designation |
| | CYMEL 327 from Allnex USA, Incorporated, Alpharetta, GA. This |
| | was diluted to 20 wt % with deionized water prior to use. |
| Epoxy 1 | A modified bisphenol A based “1”-type solid epoxy resin with a |
| | number average molecular weight 700-01100 dispersed in water. |
| | (CASRN 69761-19-9). It is an odorless white liquid with a density of |
| | 1.075 at 25 C. It is available as 46-48% solids content aqueous |
| | solution under the trade designation D.E.R. 915 from The Dow |
| | Chemical Company, Midland, MI. |
| Polyester | A film forming polyester polymer provided as an aqueous dispersion |
| Primer | containing 33% polymers solids, available under the trade designation |
| Dispersion | EASTEK 1100 POLYMER DISPERSION from Eastman Chemical |
| | Company, Kingsport, TN. |
| Surfactant | An ethoxylated, nonionic, linear alcohol surfactant having 8.9 EO |
| | groups/avg., a molecular weight of 597, and a hydroxyl number of 94 |
| | milligrams KOG/gram, available under the trade name TOMADOL |
| | T25-9 from Tomah Products, Milton, WI. This was diluted to 10 wt % |
| | with deionized water prior to use. |
| MX 150 | Acrylic particles having a crosslinked structure with an average particle |
| | size of 1.5 micrometers, available under the trade designation |
| | CHEMISNOW FUNCTIONAL FINE PARTICLES MX-150 from |
| | Soken Chemical & Engineering Company Ltd., Toshima-Ku, |
| | Tokyo. |
| Amine Catalyst | An amine blocked para-toluene sulfonic acid catalyst, a clear liquid |
| | having an active acid content of 20 weight %, available under the trade |
| | designation CYCAT 4045 from Cytec Industries, West Paterson, NJ. |
| | This was diluted to 10 wt % with deionized water prior to use. |
| IOA | Isooctyl acrylate, a colorless liquid containing 75-125 ppm |
| | monomethyl ether hydroquinone as inhibitor, >90 weight %, available |
| | from Sigma-Aldrich Co., LLC, St. Louis, MO. |
| AA | Acrylic acid, a colorless liquid, unsaturated carboxylic acid, available |
| | from Sigma-Aldrich Co., LLC, St. Louis, MO. |
| IBOA | Isobornyl acrylate, a colorless liquid, technical grade, containing 200 |
| | ppm monomethyl ether hydroquinone as inhibitor, available from |
| | Sigma-Aldrich Co., LLC, St. Louis, MO |
| Photo- | 2,2-Dimethoxy-2-phenylacetophenone, a photoinitiator having a |
| initiator | melting point between 64° C. and 67° C. and a molecular weight of |
| | 256.3 grams per mole, available under the trade designation |
| | OMNIRAD BDK from IGM Resins USA Incorporated, Charlotte, NC. |
| HDDA | Hexanediol diacrylate, available from Sigma-Aldrich Co., LLC, St. |
| | Louis, MO. |
| Triazine | 2,4-bis(trichloromethyl)-6-(3,4 dimethoxyphenyl)-s-triazine, made by |
| | the co-trimerization of an arylnitrile with trichloroacetonitrile in the |
| | presence of HCl gas and a Lewis acid such as AlCl3, AlBr3, etc., as |
| | described in Bulletin of the Chemical Society Japan, Volume 42, page |
| | 2924 (1969). |
| PET Film | Unoriented polyethylene terephthalate film having a thickness of a |
| | 0.021 inch (0.53 millimeter) and containing particulate aluminum |
| | silicate. |

### Test Methods

### Rub Resistance

Rub resistance was tested per ASTM D7835/D7835M-13: “Standard Test Method for Determining the Solvent Resistance of an Organic Coating using a Mechanical Rubbing Machine” with the following modifications. The mechanical finger, exerting a load of 900 grams and a stroke length of two inches (5.1 centimeters), was covered with four layers of dry cheese cloth.

The test specimens were prepared as follows. Samples of single sided pressure sensitive adhesive tape constructions, measuring 1 inch wide by 5 inches long (2.54 centimeters by 12.7 centimeters) and having a primer layer between the adhesive layer and the backing layer, were adhered to a stainless steel plate measuring 2 inches wide by 6 inches long (5.1 centimeters by 15.2 centimeters) using 3M CUSHION-MOUNT PLUS PLATE MOUNTING TAPE 1020R (3M Company, St. Paul, Minn.). The single sided tape was applied to the mounting tape such that the adhesive of the single sided tape was exposed. A solvent combination of 90:10 (w:w)/N-propanol:N-propyl acetate was then dripped onto the exposed adhesive surface in such a manner as to completely cover the adhesive surface.

The adhesive surface with solvent thereon was then covered with a microscope slide to prevent solvent evaporation. After one minute, the slide was removed and the adhesive surface was blotted dry using a tissue to remove any remaining solvent. The test specimen was immediately evaluated for its rub resistance using 25 double rubs of the mechanical finger. One rub consisted of one complete forward and backward motion over the exposed adhesive surface. The rubbed sample was then visually evaluated for adhesive removal. The sample was rated as “pass” if the size of the area of completely exposed primer as evidenced by a shiny, non-sticky region is 50% or less of the total solvent soaked and rubbed area. The sample was rated as “fail” if the size of the area of completely exposed primer as evidenced by a shiny, non-sticky region is more than 50% of the total solvent soaked and rubbed area. One test specimen was evaluated for each Example and Comparative Example.

### Nitrogen and Oxygen Content Method 1

The surfaces of the coated primers of Examples were examined using X-ray Photoelectron Spectroscopy (XPS), also known as Electron Spectroscopy for Chemical Analysis (ESCA), to determine the surface composition in the outermost 3 to 10 nanometers (nm) of the primer surface using the equipment and parameters listed in the table below.

### X-ray Photoelectron Spectroscopy (XPS) Analysis Equipment and Parameters

| | |
|---|---|
| Instrument | Model Thermo Scientific Nexsa ™ |
| analysis areas | ≈400 micrometers (μm) |
| photoelectron take off angle | 90° ± 30° solid angle of acceptance |
| x-ray source | Monochromatic Al Kα (1486.6eV) 72 W |
| charge neutralization | Low energy e⁻ and Ar⁺ flood sources |
| charge correction | none |
| sputter ion gun conditions | 1 keV Ar⁺ cluster size at ~6000, 2 mm by 2 mm raster |
| analysis chamber pressure | ~5 × 10⁻⁷ mbar |

Two sets of data were acquired for each Example. The first set was measured on the primer surface of test specimens which had not been laminated to an adhesive transfer tape. The second set was measured on the primer surface of test specimens which had been laminated to an adhesive transfer tape and then had the adhesive layer removed by first grasping the adhesive with a tweezers and rolling it off, to remove the bulk adhesive.

The residual adhesive remaining on the primer surface was sputtered with an Ar+ gas cluster ion beam in 10 seconds sputtering cycles for total time of 1500 to 2500 seconds till removing the adhesive residue and passing the primer layer and reaching the substrate. After each sputtering cycle, the surface composition was analyzed using X-ray Photoelectron Spectroscopy (XPS) and was shown as surface composition in atomic % versus sputtering time in seconds referred to as depth profiles.

### Nitrogen and Oxygen Content Method 2

The surfaces of the coated primers of Comparative Examples were examined using X-ray Photoelectron Spectroscopy (XPS), also known as Electron Spectroscopy for Chemical Analysis (ESCA), to determine the surface composition in the outermost 3 to 10 nanometers (nm) of the primer surface using the equipment and parameters listed in the table below.

### X-ray Photoelectron Spectroscopy (XPS) Analysis Equipment and Parameters

| | |
|---|---|
| Instrument | Model VERSAPROBE 5000 (Physical Electronics, Chanhassen, MN) |
| analysis areas | approximately 500 micrometers by 1500 micrometers |
| photoelectron take off angle | 450° ± 20° solid angle of acceptance |
| x-ray source | Monochromatic Aluminum K alpha (1486.6 electron Volts) |
| charge neutralization | Low energy e⁻ and Ar⁺ flood sources |
| charge correction | C-C/H4→ 285.0 electronVolts |
| sputter ion gun conditions | None |
| analysis chamber pressure | ca. 5 × 10⁻⁸ Torr |

Two sets of data were acquired for each Comparative Example. The first set was measured on the primer surface of test specimens which had not been laminated to an adhesive transfer tape. The second set was measured on the primer surface of test specimens which had been laminated to an adhesive transfer tape and then had the adhesive layer removed by first grasping the adhesive with a tweezers and rolling it off, to remove the bulk adhesive. The adhesive remaining on the primer surface was sputtered with a gas cluster ion beam for 30 seconds, followed by negative ion time-of-flight secondary ion mass spectrometry (ToF-SIMS) analysis to check for an increase in the nitrogen signal accompanied by a decrease in the adhesive signal. The ToF-SIMS experimental conditions are given in the table below. This process of sputtering and running a negative ion SIMS was repeated until any residual amount of adhesive was minimized and PET began to be detected in the spectrum. At this point the exposed surface was analyzed for nitrogen content using X-ray Photoelectron Spectroscopy.

ToF-SIMS experimental conditions

| | |
|---|---|
| Instrument | Model nanoTOF II (Physical Electronics, Chanhassen, MN) |
| Sputter source | 20 kiloVolt Ar2500+ (cluster size is approximate) |
| Sputter current | ~7 nanoAmperes |
| Sputter area | 2 mm × 2 mm |
| Ion source | 30 kiloVolt Bi3++ |
| Analysis area | 200 micrometers by 200 micrometers |
| Charge neutralization | Low energy electron source |
| Analysis chamber pressure | ca. 1 × 10⁻⁷ Torr |
| Secondary ion polarity | Negative |

### Preparation of Primer Solutions

### Examples 1A and 2A

Primer solutions 1A and 2A were prepared by mixing the components and amounts shown in Table 1 below in a glass four-ounce jar in the following order and times using a magnetic mixer and stir bar at a moderate rate: first PEI was added to the jar, then deionized water was slowly added and mixed for one minute. Next, Wetting Agent was added (Example 1A only) and mixed for one minute. After adding and mixing the Wetting Agent (Example 1A only), MX 150 was added with mixing for one minute, followed by addition of Epoxy 1 followed by mixing for one minute to provide primer solution 1A and 2A (at 6.16 wt % solids).

### Comparative Example 1A

Primer solution Comparative 1A was prepared by mixing the following components and amounts in a glass four-ounce jar in the following order and times using a magnetic mixer and stir bar at a moderate rate: First deionized water was added to the jar followed by PU with mixing for one minute. Next, Surfactant was added and mixed for one minute followed by addition of Polyester Polymer Dispersion and mixing for one minute. Next, MX 150 was added and mixed for one minute. Finally, Crosslinker 1 was added and mixed for another five minutes to provide primer solution Comparative 1A (at 13 wt % solids).

### Comparative Example 2A

Primer solution Comparative 2A was prepared by mixing the components and amounts shown in Table 1 below in a glass four-ounce jar in the following order and times using a magnetic mixer and stir bar at a moderate rate: first deionized water was added to the jar then the Acrylic Polymer with mixing for one minute. Next, Surfactant and MX 150 were added and mixed for one minute. This was followed by addition of Amine Catalyst and Crosslinker 2 with mixing for another five minutes to provide primer solution Comparative 2A (at 13 wt % solids).

TABLE 1
Primer Solutions

| | Deionized | | | Fluoro- | | Wetting |
|---|---|---|---|---|---|---|
| | Water | PEI | PVA | surfactant | Surfactant | Agent |
| Example | (grams) | (grams*) | (grams*) | (grams*) | (grams*) | (grams*) |
| 1 A | 13.4 | 0.937 | — | — | — | 0.020 |
| 2 A | 40.6 | 0.937 | — | — | — | — |
| Comparative | 26.35 | — | — | — | 0.05 | — |
| 1 A | | | | | | |
| Comparative | 27.0 | — | — | — | 0.5 | — |
| 2 A | | | | | | |

| | | | | Polyester | | |
|---|---|---|---|---|---|---|
| | | Cross- | | Polymer | Acrylic | Amine |
| | Epoxy 1 | linker | PU | Dispersion | Polymer | Catalyst |
| Example | (grams*) | (grams*) | (grams*) | (grams*) | (grams*) | (grams*) |
| 1 A | 0.052 | — | — | — | — | — |
| 2 A | 0.165 | — | — | — | — | — |
| Comparative | — | 3.9 | 17.7 | 2.0 | — | — |
| 1 A | | | | | | |
| Comparative | — | 3.3 | — | — | 18.6 | 0.6 |
| 2 A | | | | | | |

All examples also contained MX 150 particles at a level of 0.1 wt % of the total solids.
*Weight of material as listed in the Materials chart above, i.e., at the stated dilution or solids content.

### Preparation of Primer Coated, Oriented Films

### Examples 1B-3B and Comparative Examples 1B and 2B

The resulting primer solutions 1A-2A and Comparative 1A and 2A were used to make provide primer coated, oriented film samples of Examples 1B-3B and Comparative Examples 1B and 2B, respectively. The primer solutions were coated onto mono-axially oriented PET film using a number 6 Meyer rod (RDS Specialties, Webster, N.Y.), to provide a wet coating thickness of 8 micrometers, dried in a tenter oven for approximately 6 seconds between 100° C. and 110° C., followed by stretching four times the original sample size in the transverse (crossweb) direction using the following temperature zones and times: 1) approximately 6 seconds at a temperature between 100° C. and 110° C., 2) approximately 6 seconds at a temperature of 240° C., and 3) approximately 2 seconds at a temperature of 40° C. Next the coated, dried, oriented (stretched) films were wound up in a roll. Later, the coated/dried/stretched films were cut into rectangular shapes measuring approximately 12.7 centimeters by 25.4 centimeters (5 inches by 10 inches) to provide primer coated, oriented film samples of Examples 1B and 2B and Comparative Examples 1B and 2B.

### Preparation of Pressure Sensitive Adhesive Transfer Tape

An adhesive precursor syrup was prepared by mixing 64.5 parts by weight (pbw) IOA, 8.5 pbw AA, 27 pbw IBOA, and 0.04 pbw Photoinitiator and partially polymerizing it under a nitrogen atmosphere by exposure to an ultraviolet radiation source having a spectral output from 300-400 nanometers with a maximum at 351 nanometers to provide a syrup having a viscosity of about 3 Pa*s (3000 centipoise) and a monomer conversion of about 8%. Next, 0.15 parts of Triazine, 0.175 parts of HDDA, and an additional 0.12 parts of Photoinitator were added to the syrup and fully dissolved to give the final coatable adhesive precursor syrup. This syrup was then knife coated onto the embossed side of a release liner and exposed to ultraviolet radiation by means of a series of lamps having a spectral output from 300-400 nanometers with at maximum at 351 nanometers in a nitrogen-rich atmosphere for a time of 105 seconds to provide a total dose of 510 milliJoules/square centimeter as measured using a calibrated

NIST radiometer. An adhesive transfer tape having pressure sensitive adhesive (PSA) layer, approximately 0.002 inches (51 micrometers) thick, on the embossed surface of the release liner was thereby obtained. The adhesive transfer tape was stored at ambient conditions prior to use.

### Preparation of Adhesive Coated, Oriented Primed Films

### Examples 1C-3C and Comparative Examples 1C and 2C

Primer coated, oriented films, measuring approximately 12.7 centimeters by 25.4 centimeters (5 inches by 10 inches), were placed on a flat surface with the primer coated side facing up (exposed). The PSA adhesive transfer tape was laminated to the exposed primer surface, with its' adhesive surface in contact with the primer surface, by hand using a six inch diameter rubber roller and rolling back and forth two times. A construction having, in order, an oriented film, a primer coating, and adhesive layer, and an embossed liner was obtained. After removal of the liner the resulting tape articles were evaluated for rub resistance, and nitrogen and oxygen content as described in the test methods above. The results are shown in Table 2.

TABLE 2
Results

| | Rub | Primed Only | | | Primed & Adhesive Removed | | |
|---|---|---|---|---|---|---|---|
| | Resistance | | | % O/ | | | % O/ |
| Ex. | (Pass/Fail) | % N | % O | % N | % N | % O | % N |
| 1C | P | 23.3 | 8.5 | 0.4 | 13.7 | 12.3 | 0.9 |
| 2C | P | 19.3 | 12.1 | 0.6 | 6.3 | 17.9 | 2.9 |
| 3C | P | NM | NM | NM | NM | NM | NM |
| CE 1C | F | 5.1 | 23.3 | 4.6 | 5.8 | 22.9 | 3.9 |
| CE 2C | F | 3.5 | 27.4 | 7.8 | 2.8 | 27.4 | 9.8 |

NM = not measured

Best results were found where the Atomic Weight percent of the Nitrogen was greater than 6% and the Ratio of Atomic weight percent of Oxygen to Nitrogen was less than 3.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A primer layer for adhesion of a pressure sensitive adhesive material to a substrate, the primer layer comprising a cured primer which is the reaction product of an epoxy resin and a polyamine, wherein the polyamine is a polyethyleneimine, a polyvinylamine, or a combination thereof

2. The primer layer of claim 1, wherein the epoxy resin is an aromatic epoxy resin.

3. (canceled)

4. The primer layer of claim 1, wherein the polyamine is a polyethylenimine.

5. The primer layer of claim 1, wherein the polyamine is a polyvinylamine.

6. A two-layer construction comprising the primer layer of claim 1 and a substrate layer.

7. The two-layer construction of claim 6, wherein the substrate layer comprises one or more polyester polymers.

8. The two-layer construction of claim 6, wherein the substrate layer comprises one or more polymers comprising aromatic groups.

9. The two-layer construction of claim 6, wherein the substrate layer comprises polyethylene terephthalate (PET).

10. The two-layer construction of claim 6, wherein the substrate layer comprises an oriented film.

11. A tape comprising:
a substrate layer;
a primer layer on the substrate layer, wherein the primer layer comprises a cured primer which is the reaction product of an epoxy resin and a polymeric polyamine; and
a first pressure sensitive adhesive layer comprising a pressure sensitive adhesive material on the primer layer.

12. The tape of claim 11, wherein the pressure sensitive adhesive material comprises polyacrylate polymer.

13. The tape of claim 11, wherein the pressure sensitive adhesive material comprises a polymer comprising acidic polar monomer units.

14. The tape of claim 11, wherein the pressure sensitive adhesive layer is directly bound to the primer layer.

15. The tape according to claim 11, further comprising a second pressure sensitive adhesive layer borne on a face of the tape opposite the first pressure sensitive adhesive layer.

16. The tape according to claim 11, further comprising a foam layer.

17. A method of making the two-layer construction of claim 6, the method comprising:
a) providing the substrate layer; and
b) coating the substrate layer with a coating mixture comprising a curable aromatic epoxy resin and the polyamine.

18. The method of claim 17, further comprising:
c) reacting the curable aromatic epoxy resin with the polyamine so as to generate the primer layer comprising the cured primer.

19. The method according to claim 17, further comprising:
d) stretching the substrate layer in a first direction; and
e) stretching the substrate layer in a second direction.

20. The method of claim 19, wherein a) through e) are carried out in the order a), d), b), c), e).

21. The tape of claim 11, wherein the polymeric polyamine is a polyethyleneimine, a polyvinylamine, or a combination thereof.
